(19) United States
(12) Patent Application Publication
(10) Pub. No.: US 2008/0121258 A1
(43) Pub. Date: May 29, 2008

(54) Walker with folding seat

(76) Inventor: Mei Ru Lin, Waipu Township (TW)

Correspondence Address: PRO-TECHTOR INTERNATIONAL SERVICES, 20775 NORADA CT., SARATOGA, CA, 95070, US

(21) Appl. No.: 11/606,250

(22) Filed: Nov. 28, 2006

(51) Int. Cl. A61H 3/00

(52) U.S. Cl. 135/67; 135/74

(57) ABSTRACT

A foldable walker in one embodiment includes right and left side frames, a front frame, and a seat including two U-shaped seat frame members pivotably connected together and each including a toothed member along a lower portion at either end, two side links each having one end pivotably secured to the front frame and the other end pivotably secured to the seat pivot, and a canopy mounted on the seat. Lifting a middle of the seat and continuously pushing one seat frame member toward the front frame will fold one seat frame member downward toward the other seat frame member, counterclockwise pivot one ends of the links relative to the front frame, pivot the other ends of the links about the seat pivots, and fold the seat with the front frame by engaging the toothed members of one seat frame member with that of the other seat frame member.

### BACKGROUND OF THE INVENTION

1. Field of Invention

The invention relates to walkers and more particularly to a collapsible walker having a folding seat.

2. Description of Related Art

A conventional collapsible walker is shown in FIGS. 1 and 2. The frame of the walker comprises two side frames each including a rear leg 12, a bent handle 10, and a cross brace 11; and a front frame including two front legs 32, a telescopic upper support member 20, and a lower support member 30 in which the lower support member 30 has two upright sleeves 31 at both ends, each sleeve 31 having a lower portion secured to the front leg 32 and an upper portion rotatably secured to the handle 10, each cross brace 11 is fixedly interconnected the front leg 32 and the rear leg 12 at the same side, and the upper support member 20 has both ends rotatably connected to the handles 10 and includes an intermediate lock device 21 for locking its right section to its left section which adjustably sleeves on the right section.

The open position of the walker is shown in FIG. 1. When the walker is not being used, a user may fold the walker by unlocking the sleeves 31, unlocking the lock device 21, inwardly rotating the right side frame relative to the front frame until the right side frame is about parallel with the front frame with the right section of the upper support member 20 further received in the left section of the upper support member 20, inwardly rotating the left side frame relative to the front frame until the left side frame is about parallel with both the front frame and the right side frame with the right section of the upper support member 20 further received in the left section of the upper support member 20, locking the lock device 21, and locking the sleeves 31. The closed position of the walker is shown in FIG. 2.

However, the prior art walker suffered from a disadvantage. For example, no seat is provided by the walker since it is understood that many of the aged or infirmed may need a rest while doing rehabilitation. Moreover, provision of the seat needs to consider how to facilitate the walker user using toilet. Thus, continuing improvements in the exploitation of walker are constantly being sought.

### SUMMARY OF THE INVENTION

It is therefore one object of the invention to provide a foldable walker comprising right and left side frames each including a rear leg, a handle, and a cross brace; a front frame including two front legs, a telescopic upper support member having two ends rotatably connected to the handles respectively and includes a right section, a left section adjustably sleeved on the right section, and an intermediate lock device for locking the right section to the left section, and a lower support member having two upright sleeves at both ends respectively, each sleeve having a lower portion secured to the front leg and an upper portion rotatably secured to the handle wherein each cross brace is fixedly interconnected the front leg and the rear leg; and a rectangular seat including two U-shaped seat frame members each including a toothed member along a lower portion at either end, two connection members each pivotably secured to the ends of the seat frame members, two side links each having one end pivotably secured to a lower end of the sleeve and the other end pivotably secured to the connection member, and a sitting member mounted on the joined seat frame members wherein a tooth at one end of the toothed member of one seat frame member is engaged with the tooth at one end of the toothed member of the other seat frame member in an extended position of the seat, whereby lifting a middle portion of the seat and continuously pushing one seat frame member toward the front frame will fold one seat frame member downward toward the other seat frame member, counterclockwise pivot one ends of the links relative to the sleeves pivot the other ends of the links about the connection members, and fold the seat between the sleeves by engaging teeth of the toothed members of one seat frame member with that of the toothed members of the other seat frame member; and whereby unlocking the sleeves, unlocking the lock device, inwardly rotating the right side frame relative to the front frame until the right side frame is about parallel with the seat and the front frame with the right section of the upper support member further received in the left section of the upper support member, inwardly rotating the left side frame relative to the front frame until the left side frame is about parallel with the seat, the front frame, and the right side frame with the right section of the upper support member further received in the left section of the upper support member, locking the lock device, and locking the sleeves will fold the walker in a closed position.

In one aspect of the invention the sitting member is canopy.

In another aspect of the invention the sitting member comprises a plurality of elongate plates in parallel.

The above and other objects, features and advantages of the invention will become apparent from the following detailed description taken with the accompanying drawings.

### BRIEF DESCRIPTION OF THE DRAWINGS

FIG. 1 is a perspective view of a conventional walker in an open position;

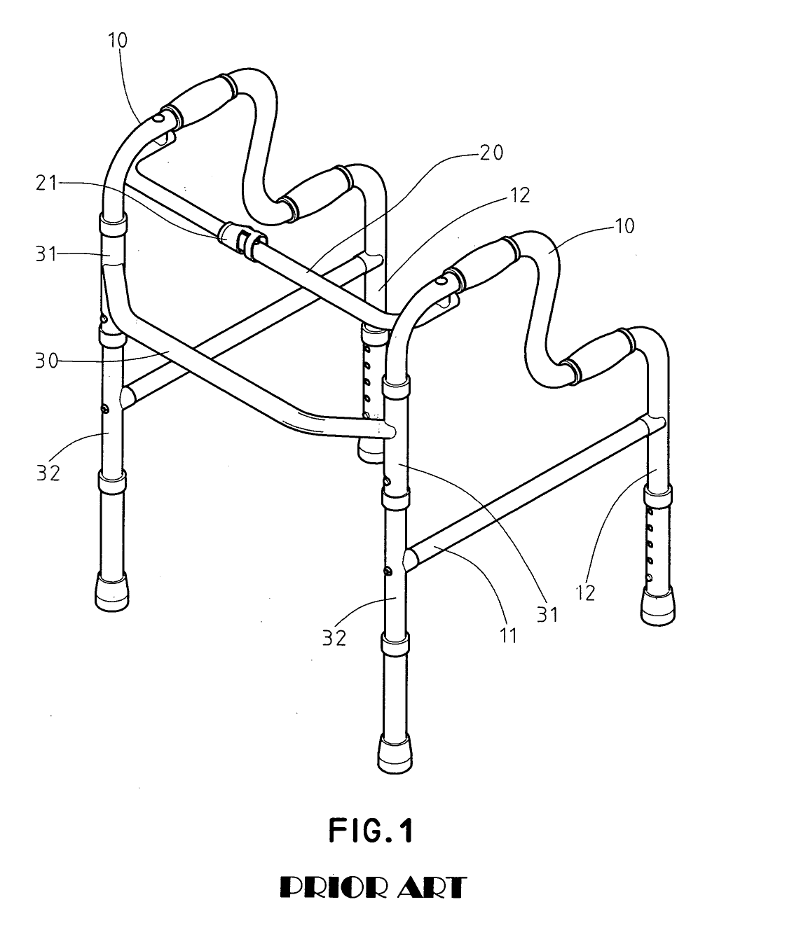

FIG. 2 is a perspective view of the walker in a closed position after collapsing;

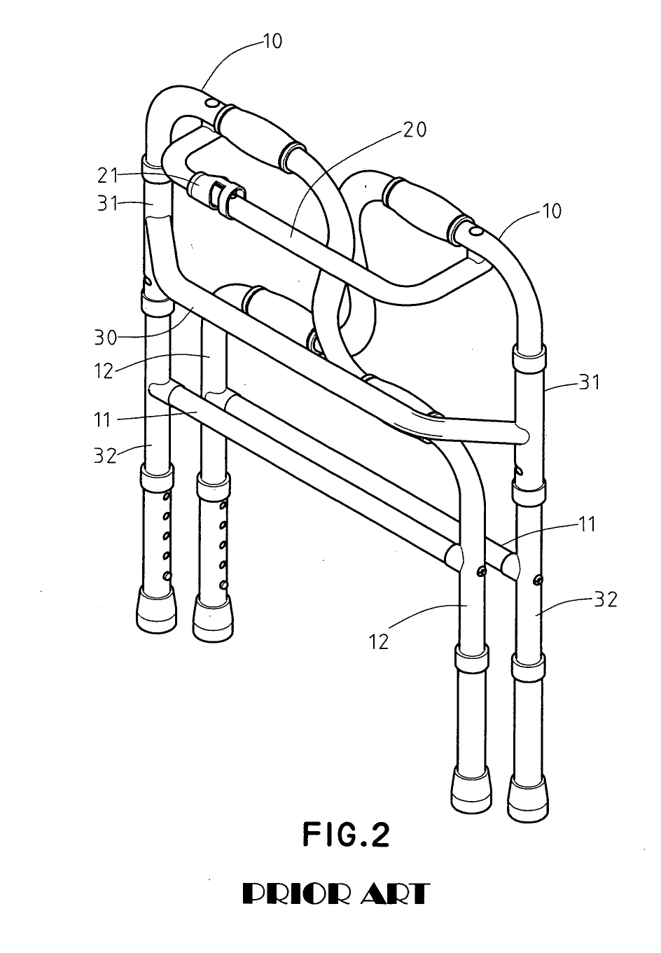

FIG. 3 is a perspective view of a preferred embodiment of walker according to the invention where the walker is in an open position;

FIG. 4 is an exploded perspective view of a first configuration of the seat;

FIG. 5 is an exploded perspective view of the seat frame;

FIG. 6 is a side elevation of FIG. 3 illustrating steps of folding the seat;

FIG. 7 is a perspective view of the walker with the seat folded;

FIG. 8 is a perspective view of the folded walker;

FIG. 9 is a side elevation showing the not engaged toothed members prior to seat folding;

FIG. 10 is a view similar to FIG. 9 where the toothed members turns to engage each other while folding the seat; and

FIG. 11 is an exploded perspective view of a second configuration of walker seat according to the invention.

### DETAILED DESCRIPTION OF THE INVENTION

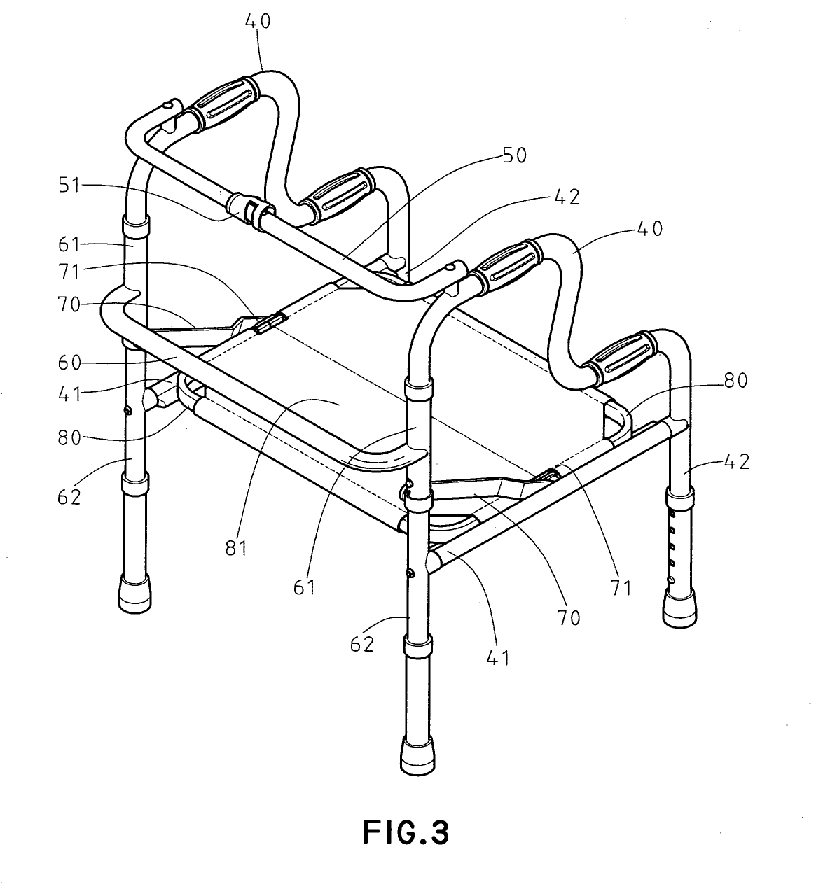

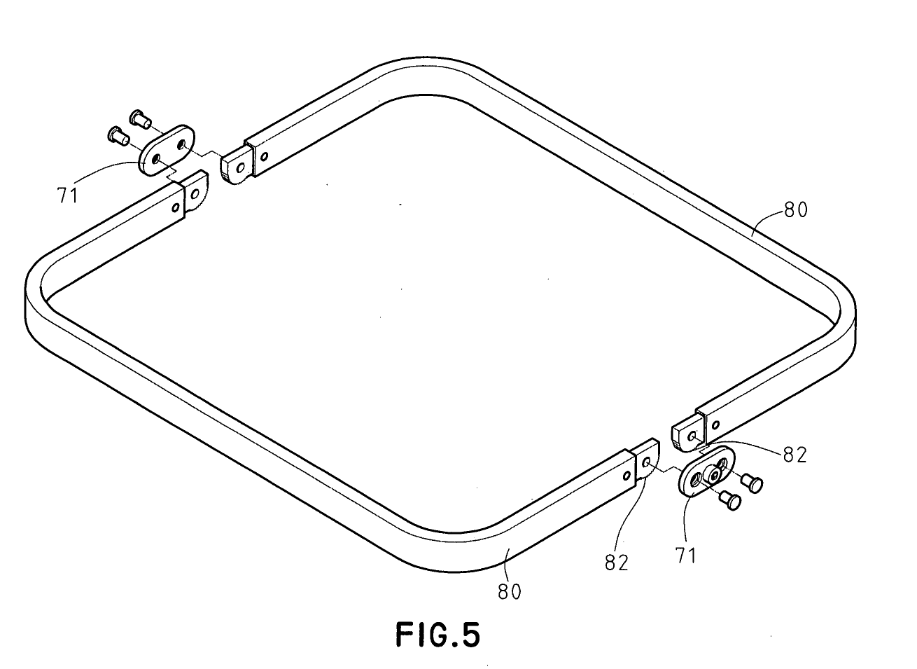

Referring to FIGS. 3 to 10, a collapsible walker in accordance with a preferred embodiment of the invention is shown. The walker comprises two side frames each including a rear leg 42, a bent handle 40, and a cross brace 41; and a front frame including two front legs 62, a telescopic upper support member 50, and a lower support member 60.

The lower support member 60 has two upright sleeves 61 at both ends. Each sleeve 61 has a lower portion secured to the front leg 62 and an upper portion rotatably secured to the handle 40. Each cross brace 41 is fixedly interconnected the front leg 62 and the rear leg 42 at the same side. The upper support member 50 has both ends rotatably connected to the handles 40 and includes an intermediate lock device 51 for locking its right section to its left section which adjustably sleeves on the right section.

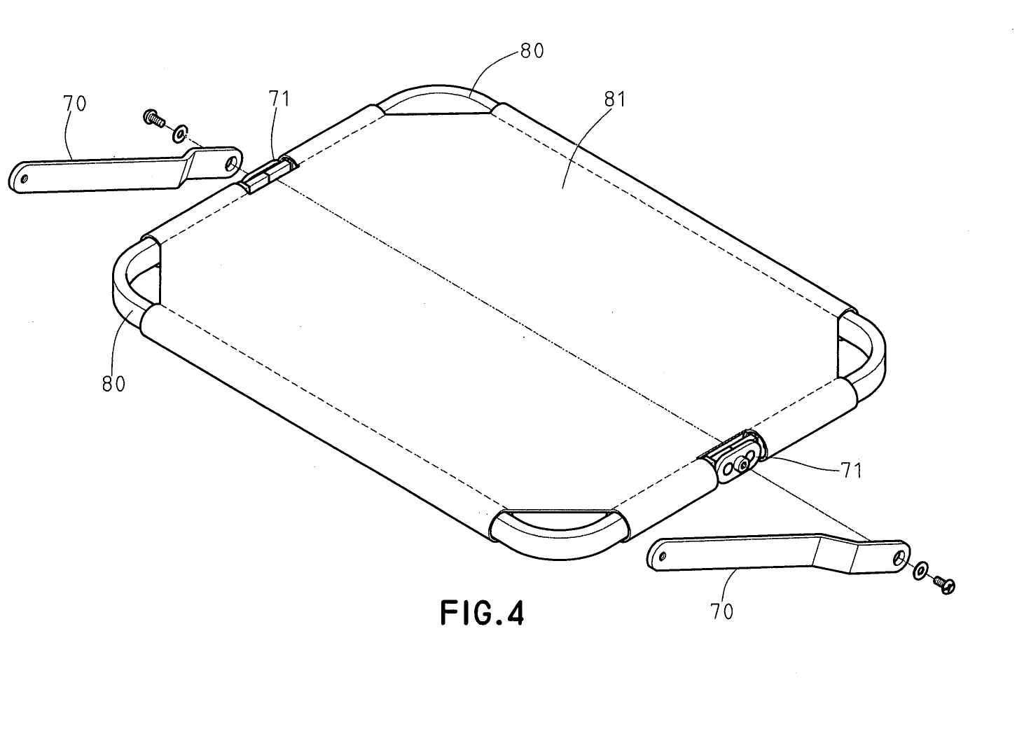

The characteristic of the invention is the provision of a folding seat for receiving an aged or infirmed in a sitting position (i.e., rest) as he or she does rehabilitation. The rectangular seat comprises two U-shaped seat frame members 80 each including a through hole 83 at either end and a toothed member 82 along a lower portion at either end; two substantially elliptical connection members 71 each including two end through holes each pivotably secured to the through hole 83 by means of a fastener, and an intermediate through hole; two side links 70 each having one end pivotably secured to a lower end of the sleeve 61 and the other end pivotably secured to the intermediate through hole of the connection member 71 by means of a fastener; and a canopy 81 mounted on the joined seat frame members 80 with four corners of the seat frame members 80 and the connection members 71 exposed (see FIG. 4).

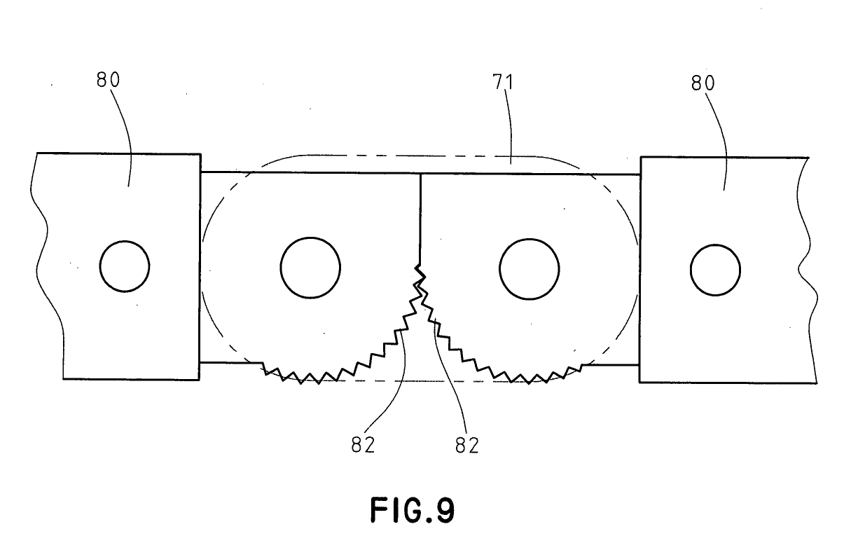

The connection of the seat frame members 80 at either side of the walker is shown in FIG. 9. As shown, either end of one seat frame member 80 is engaged with the corresponding end of the other seat frame member 80. Also, only a tooth at one end of the toothed member 82 of one seat frame member 80 is engaged with the tooth at one end of the toothed member 82 of the other seat frame member 80.

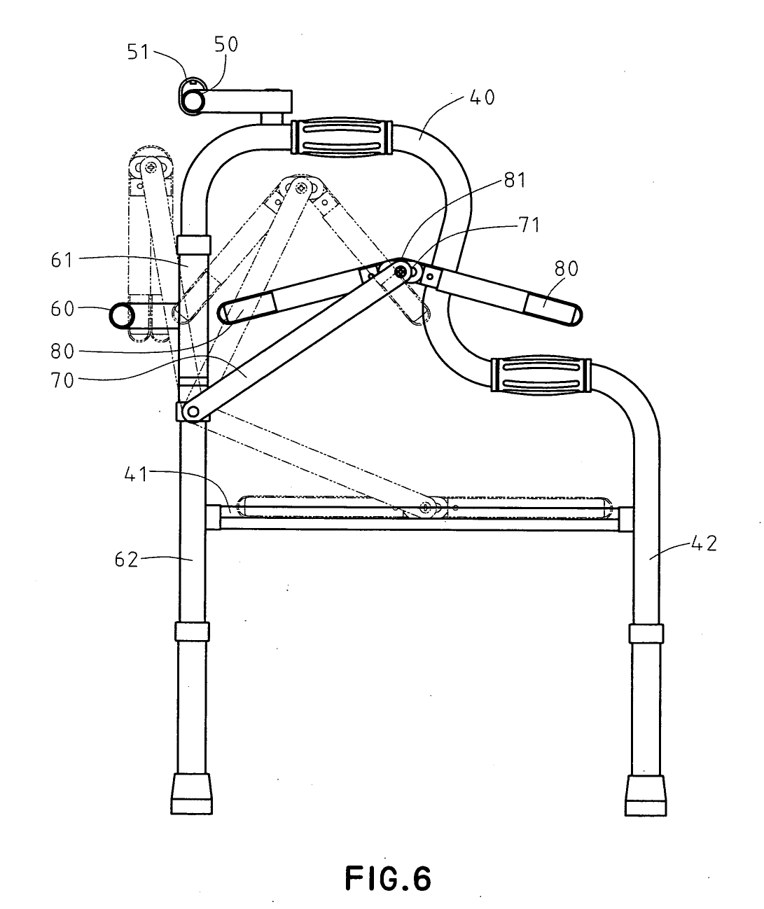

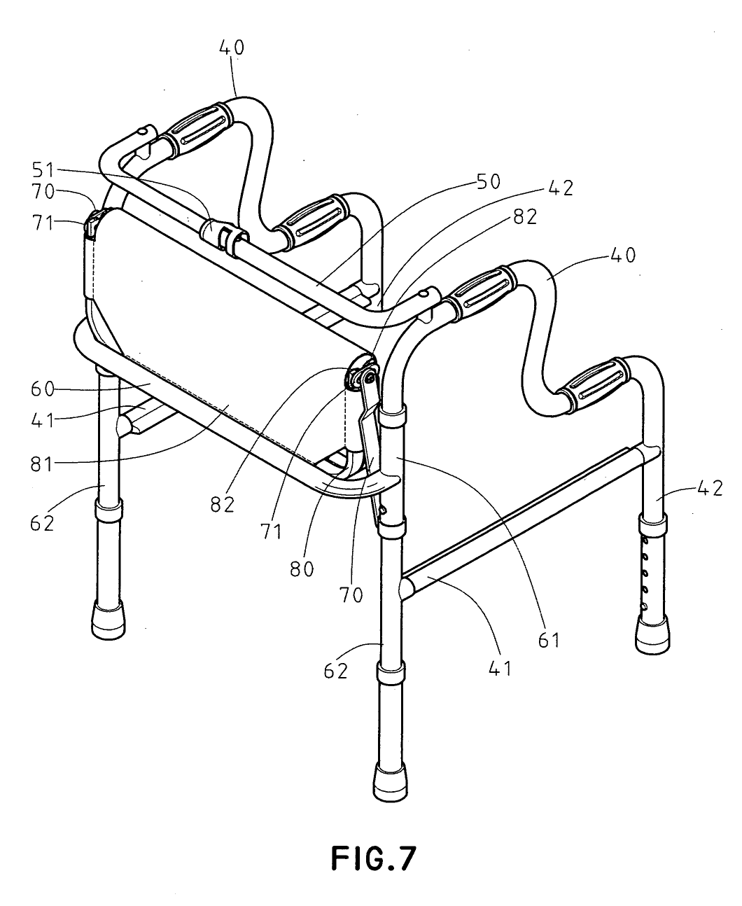

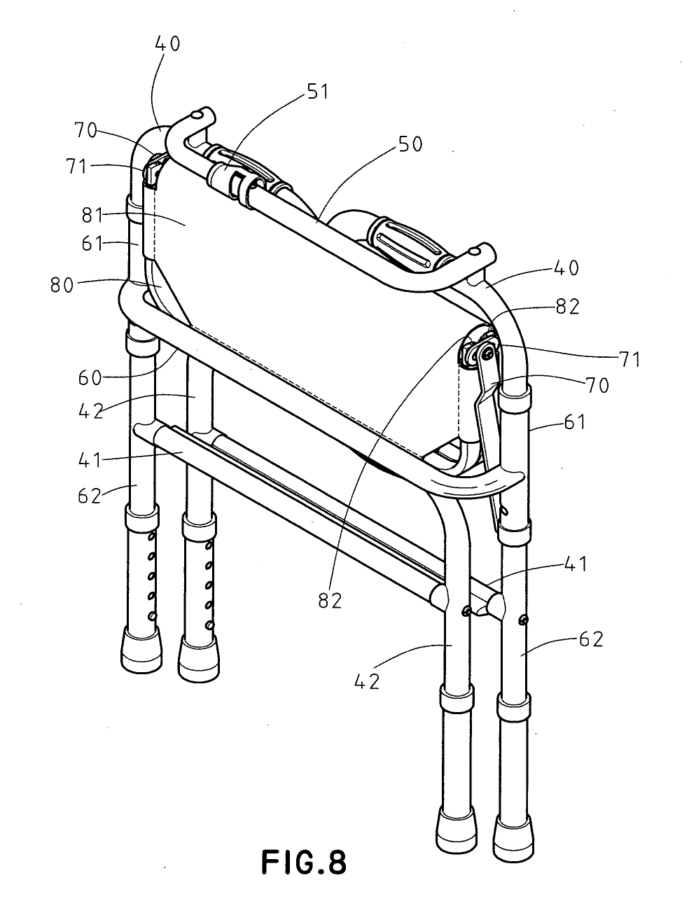

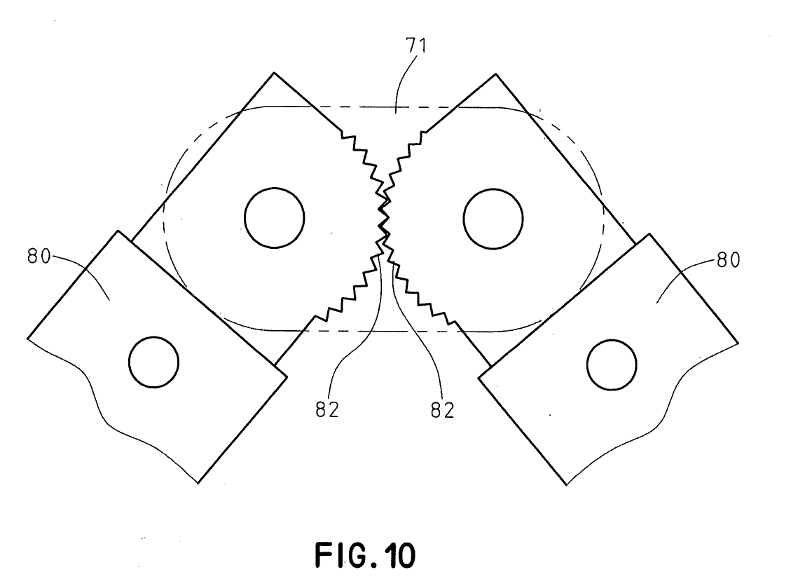

Folding operations of the seat and the walker frame of the invention will be described in detailed below by referring to FIGS. 6 to 10. First, a user may push the front seat frame member 80 and lift a middle portion of the seat. As such, at either side of the walker the front seat frame member 80 folds downward toward the rear seat frame member 80, one end of the link 70 counterclockwise pivots relative to the sleeve 61, and the other end of the link 70 pivots about the connection member 71 until the seat is completely folded substantially rearward of the sleeves 61 (see FIG. 7). As shown in FIG. 7, the walker is disposed in a position adapted to facilitate the user using toilet by sitting between the side frames. At the seat folding process, teeth of the toothed member 82 of the front seat frame member 80 gradually engage with that of the toothed member 82 of the rear seat frame member 80 (i.e., gear engagement) as the seat frame members 80 pivot toward each other (see FIG. 10). After folding the seat, the user may fold the walker by unlocking the sleeves 61, unlocking the lock device 51, inwardly rotating the right side frame relative to the front frame until the right side frame is about parallel with both the seat and the front frame with the right section of the upper support member 60 further received in the left section of the upper support member 60, inwardly rotating the left side frame relative to the front frame until the left side frame is about parallel with the seat, the front frame, and the right side frame with the right section of the upper support member 60 further received in the left section of the upper support member 60, locking the lock device 51, and locking the sleeves 61. The closed position of the walker is shown in FIG. 8.

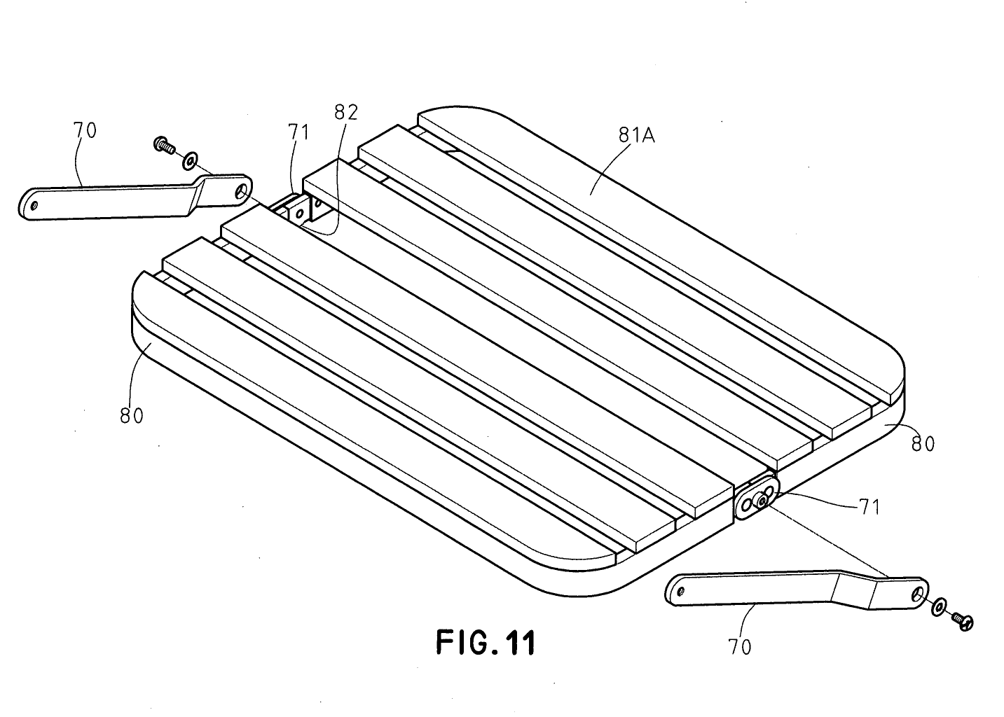

Referring to FIG. 11, a second configuration of walker seat according to the invention is shown. The characteristic of the second configuration of the seat is that the canopy 81 of the first configuration of the seat is replaced by a plurality of elongate wood or metal plates 81A in parallel.

While the invention herein disclosed has been described by means of specific embodiments, numerous modifications and variations could be made thereto by those skilled in the art without departing from the scope and spirit of the invention set forth in the claims.

What is claimed is:

1. A foldable walker comprising:
right and left side frames each including a rear leg, a handle, and a cross brace;
a front frame including two front legs, a telescopic upper support member having two ends rotatably connected to the handles respectively and includes a right section, a left section adjustably sleeved on the right section, and an intermediate lock device for locking the right section to the left section, and a lower support member having two upright sleeves at both ends respectively, each sleeve having a lower portion secured to the front leg and an upper portion rotatably secured to the handle wherein each cross brace is fixedly interconnected the front leg and the rear leg; and
a rectangular seat including two U-shaped seat frame members each including a toothed member along a lower portion at either end, two connection members each pivotably secured to the ends of the seat frame members, two side links each having one end pivotably secured to a lower end of the sleeve and the other end pivotably secured to the connection member, and a sitting member mounted on the joined seat frame members wherein a tooth at one end of the toothed member of one seat frame member is engaged with the tooth at one end of the toothed member of the other seat frame member in an extended position of the seat,
whereby lifting a middle portion of the seat and continuously pushing one seat frame member toward the front frame will fold one seat frame member downward toward the other seat frame member, counterclockwise pivot one ends of the links relative to the sleeves, pivot the other ends of the links about the connection members, and fold the seat between the sleeves by engaging teeth of the toothed members of one seat frame member with that of the toothed members of the other seat frame member; and
whereby unlocking the sleeves, unlocking the lock device, inwardly rotating the right side frame relative to the front frame until the right side frame is about parallel with the seat and the front frame with the right section of the upper support member further received in the left section of the upper support member, inwardly rotating the left side frame relative to the front frame until the left side frame is about parallel with the seat, the front frame, and the right side frame with the right section of the upper support member further received in the left section of the upper support member, locking the lock device, and locking the sleeves will fold the walker in a closed position.

2. The foldable walker of claim 1, wherein the sitting member is canopy.

3. The foldable walker of claim 1, wherein the sitting member comprises a plurality of elongate plates in parallel.
